(19) United States
(12) Patent Application Publication
(10) Pub. No.: US 2002/0016720 A1
(43) Pub. Date: Feb. 7, 2002

(54) Teledermatology consult management system and method

(76) Inventors: Ronald K. Poropatich, Bethesda, MD (US); Thomas R. Bigott, Rockville, MD (US); Jorge L. Ribas, Galthersburg, MD (US); Vladimir Bedanov, North Potomac, MD (US); Zhegyi Sun, Herdon, VA (US); Mark L. Welch, McLean, VA (US); Hon S. Pak, San Antonio, TX (US); Brian M. Davis, Alexandria, VA (US); Carl E. Boocks, Sykesville, MD (US)

Correspondence Address: Frederick Samuels, Cahn & Samuels , LLP, Suite 200, 2000 P Street, N.W., Washington, DC, 20036, US

(21) Appl. No.: 09/789,703

(22) Filed: Feb. 22, 2001

Related U.S. Application Data
(60) Provisional application No. 60/183,825, filed on Feb. 22, 2000.

(51) Int. Cl. G06F 17/60

(52) U.S. Cl. 705/3

(57) ABSTRACT

The invention provides a store and forward type electronic consult record with sufficient information for a dermatological specialist or consultant to render a diagnosis and to electronically submit that diagnosis back to the referring provider either in real time or at a later time. Accordingly, the invention provides a series of user interfaces or templates for collecting data from referring provider relating to the patient and the patient's condition. The information is then assembled into a dermatological consult record that may be stored and/or transmitted to a remote computer where it may be accessed by a consulting provider. The consulting provider may access the dermatological consult record at any time, review the record, add a diagnosis and/or treatment recommendation to the record, store the record and electronically transmit the record back to the referring provider. The referring provider may then administer treatment to the patient as recommended.

### CROSS-REFERENCE TO RELATED APPLICATIONS

This application claims priority from provisional application Ser. No. 60/183,825, filed Feb. 22, 2000, which is hereby incorporated herein by reference.

### STATEMENT REGARDING FEDERALLY SPONSORED RESEARCH

Not Applicable.

### BACKGROUND OF THE INVENTION

1. Field of the Invention

The invention relates generally to the field of telemedicine and, more particularly, to systems, methods and articles of manufacture for facilitating consultation/communication between referring and consulting providers in the field of dermatology.

2. Description of the Related Art

Telemedicine has been defined as the use of information technology to deliver medical services and information from one location to another as a substitute for face-to-face contact between provider and client (1), so that provider and client do not have to be in the same place (2). Teledermatology is the use of telemedicine to provide dermatologic care.

Radiology, pathology and dermatology are all visually-based specialties; however, with existing technologyand the nature of the specialties, it appears that dermatology has the best “fit” with telemedicine. Patients frequently do not need a physician to tell them that they have a skin problem and it is consistently shown that dermatologist provide the most cost-efficient, highest-quality care for skin diseases when their services are compared to other health professionals. Various studies indicate that practitioners in other fields are notoriously poor at diagnosing skin problems (16-86% errors in diagnosis even with commonly seen skin problems).

Accuracy of teledermatologic diagnosis is consistently high (up to 100%) and is considered “equivalent” to the diagnosis made by clinic dermatologists who had examined the patient in person. Technical factors of lighting and camera positioning can prohibit accurate diagnosis. The inability to appreciate depth partially is overcome by manipulation of the direction of incident lighting onto the skin. In one study even using expensive, bulky, black-and-white equipment, the use of video was reported to be “effective, highly acceptable” to both patients and physicians, and to be cost-effective.

Parameters of interest include: control examinations, lesion clarity, colour helpfulness, supervisory completeness by the physician's assistant, and patient reaction. It is believed that the quality of the physician-patient relationship is “not modified” by the technology, with no significant differences in patient attitude between the simulated and remote consultations. Dermatologist, however, are not always so certain.

Time for a dermatologic teleconsultation may increase until experience is acquired, thereafter the time for teleconsultation will likely decrease. Some studies show that dermatologists have preferred store and forward technology as the asynchronous mode is time-efficient for them (images take time to transmit). However, with this technology they cannot ask for additional views. In live interactive transmission require the referring health care provider to be present (not necessary with store and forward technology).

Accordingly, there is a need for a technology that will allow remote providers to communicate with consulting specialists who can perform expert diagnosis in near real time.

### SUMMARY OF THE INVENTION

1. In accordance with an aspect of the invention, a computer system is provided that generates a patient's dermatological consult record. The computer system displays one or more prompts for entry of data relating to the patient's dermatological history. The computer system further displays one or more prompts for entry of data relating to physical examination of the patient. The computer system additionally displays one or more prompts for selection of images of body parts of the patient populated with dermatological abnormalities Responsive to entry of the patient's dermatological history data, the patient's examination results and the selection of images, the computer system displays a dermatological consult record including a patient history data field, a physical examination data field and an image data field.

### BRIEF DESCRIPTION OF THE DRAWINGS

FIG. 1 is a block diagram showing a computer system in accordance with the invention.

FIGS. 2-13 show various user interfaces in accordance with the invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein;

rather, these embodiments are provided so that this disclosure will be thorough and complete, and will fully convey the scope of the invention to those skilled in the art. The present invention will now be described more fully hereinafter with reference to the accompanying drawings, in which preferred embodiments of the invention are shown. Like numbers refer to like elements throughout.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

Computer program code for carrying out operations of the present invention is preferably written in an object oriented programming language such as Java®, Smalltalk or C++. However, the computer program code for carrying out operations of the present invention may also be written in conventional procedural programming languages, such as the “C” programming language. The program code may execute entirely on the user's computer, as a stand-alone software package, or it may execute partly on the user's computer and partly on a remote computer. In the latter scenario, the remote computer may be connected directly to the user's computer through a LAN or a WAN (Intranet), or the connection may be made indirectly through an external computer (for example, through the Internet using an Internet Service Provider).

The present invention is described below with reference to flowchart illustrations of methods, apparatus (systems) and computer program products according to an embodiment of the invention. It will be understood that each block of the flowchart illustrations, and combinations of blocks in the flowchart illustrations, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks. In general, the present invention defines a dermatology consult management system and method. The invention provides a store and forward type electronic consult record with sufficient information for a dermatological specialist or consultant to render a diagnosis and to electronically submit that diagnosis back to the referring provider either in real time or at a later time. Accordingly, the invention provides a series of user interfaces or templates for collecting data from referring provider relating to the patient and the patient's condition. The information is then assembled into a dermatological consult record that may be stored and/or transmitted to a remote computer where it may be accessed by a consulting provider. The consulting provider may access the dermatological consult record at any time, review the record, add a diagnosis and/or treatment recommendation to the record, store the record and electronically transmit the record back to the referring provider. The referring provider may then administer treatment to the patient as recommended.

### Hardware and Software for Implementing the Present Invention

A template according to the present invention may be stored locally on a provider's stand-alone computer terminal, such as a desktop computer, laptop computer, palmtop computer, or personal digital assistant (PDA) or the like. Exemplary stand-alone computers may include, but are not limited to, Apple®, Sun Microsystems®, IBM®, or IBM®-compatible personal computers. Accordingly, the present invention may be carried out via a single computer system, such as a desktop computer or laptop computer.

According to a preferred embodiment, a template may be centrally stored within one or more computers accessible to multiple users. Accordingly, users may access a central template through a private or public computer network in a conventional manner via wireline or wireless communications. By maintaining a template in a central location, updates can be made to the template easily made by the system administrator without having to access all of the machines in the network.

The present invention is preferably practiced within a client/server programming environment. As is known by those skilled in this art, client/server is a model for a relationship between two computer programs in which one program, the client, makes a service request from another program, the server, which fulfills the request. Although the client/server model can be used by programs within a single computer, it is more commonly used in a network where computing functions and data can more efficiently be distributed among many client and server programs at different network locations.

Many medical software applications use the client/server model as does the Internet's main program, TCP/IP. Typically, multiple client programs share the services of a common server program. Both client programs and server programs are often part of a larger program or application. Relative to the Internet, a Web browser is a client program that requests services (the sending of Web pages or files) from a Web server (which is often referred to as a Hypertext Transport Protocol or HTTP server) in another computer connected to Internet. Similarly, a computer with TCP/IP installed allows client requests for files from File Transfer Protocol (FTP) servers in other computers on the Internet.

As is known to those with skill in this art, client/server environments may include public networks, such as the Internet, and private networks often referred to as “Intranets” and “Extranets.” The term “Internet” shall incorporate the terms “Intranet” and “Extranet” and any references to accessing the Internet shall be understood to mean accessing an Intranet and/or an Extranet, as well. The term “computer network” shall incorporate publicly accessible computer networks and private computer networks.

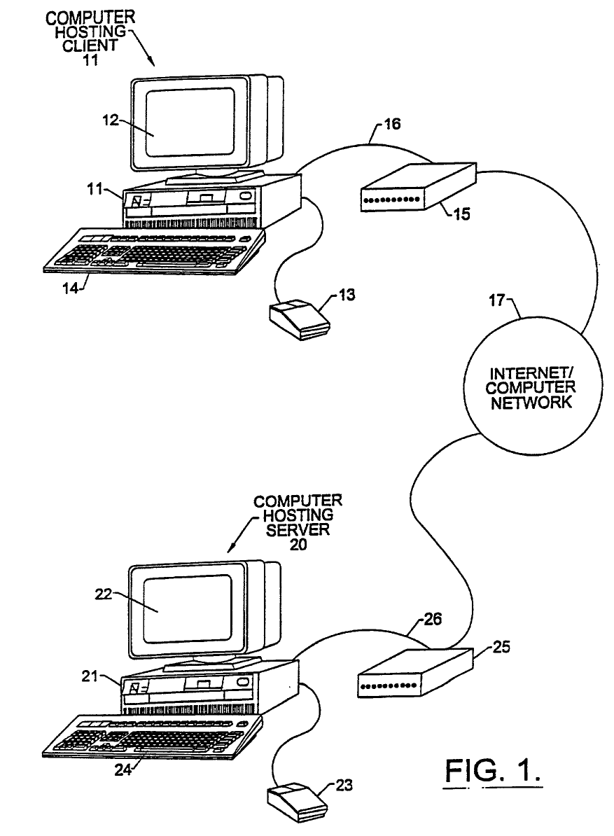

FIG. 1 illustrates a client/server computing system in which the present invention may be embodied. In the illustrated system, a remote user's computer 10 has a client application resident thereon and a host computer 20 has a server application resident thereon. The user's computer 10 preferably includes a central processing unit 11, a display 12, a pointing device 13, a keyboard 14, access to persistent data storage, and a communications link 16 for communicating with the host computer 20. The keyboard 14, having a plurality of keys thereon, is in communication with the central processing unit 11. A pointing device 13, such as a mouse, is also connected to the central processing unit 11. The communications link 16 may be established via a modem 15 connected to traditional phone lines, via DSL lines, an ISDN link, a T1 link, a T3 link, via cable television, via an ethernet network, and the like. Modem 15 may also be a wireless modem configured to communicate with the modem 25 of the host computer 20 via wireless communications systems. The communications link 16 also may be made by a direct connection of the user's computer 10 to the host computer 20 or indirectly via a computer network 17, such as the Internet, in communication with the host computer 20.

The central processing unit 11 contains one or more microprocessors (not shown) or other computational devices and random access memory (not shown) or its functional equivalent, including but not limited to, RAM, FLASHRAM, and VRAM for storing programs therein for processing by the microprocessor(s) or other computational devices. A portion of the random access memory and/or persistent data storage, referred to as “cache,” is often utilized during communications between a user's computer 10 and a host computer 20 to store various data transferred from the host computer.

Preferably, a user's computer 10 has an Intel® Pentium® processor (or equivalent) with at least thirty-two megabytes (32 MB) of RAM, more preferably 64 MB of RAM or greater, and at least five megabytes (5 MB) of persistent computer storage 15 for caching. However, it is to be understood that various processors may be utilized to carry out the present invention without being limited to those enumerated herein. Although a color display is preferable, a black and white display or standard broadcast or cable television monitor may be used. It is further preferred that user's computer 10 be provided with a client application in the form of a browser such as Netscape Navigator® or Internet Explorer®. Exemplary user computers having a client application resident thereon may include, but are not limited to, an Apple®, Sun Microsystems®, IBM®, or IBM®-compatible personal computer. A user's computer 10, if an IBM®, or IBM®-compatible personal computer, preferably utilizes either a Windows®3.1, Windows 95®, Windows 98®, Windows NT®, Unix®, or OS/2® operating system. However, other operating systems may also be utilized without limitation. In addition, it is to be understood that a terminal not having computational capability, such as an IBM®3270 terminal or a network computer (NC), or having limited computational capability, such as a network PC (Net PC) may be utilized in accordance with the present invention for accessing a host computer 20 in a client capacity.

A host computer 20 may have a configuration similar to that of a user's computer 10 and may include a central processing unit 21, a display 22, a pointing device 23, a keyboard 24, access to persistent data storage 25, and a communications link 26 for connecting to the user's computer 10 via a modem 25, or otherwise. It is preferable that a host computer have an Intel® Pentium® processor or equivalent, at least thirty-two megabytes (32 MB) of RAM, more preferably 64 MB of RAM or greater, and two storage devices, one for data and the other for systems and application software. The storage for data preferably has at least 20 Gigabytes of storage and the data storage device for systems and application software preferably includes at least 4 Gigabytes of storage. Hard drives are particularly preferred storage devices. However, other storage devices with the required capacity such as optical and tape devices are suitable. Host computer 20 also may be implemented using other processors and via other computing devices, including, but not limited to, mainframe computing systems and mini-computers.

Host computer 20 preferably is provided with a web server and a database. A preferred web server is O'Reilly's Web Site Professional 2.0 and a preferred database is Microsoft's SQL database. The various templates that comprise the invention may be created using any known web page creation tool such as Netscape 4.0 with JAVA. The templates may be linked to the database using an interface program such as Allaire Cold Fusion 3.0.

It is understood that a user's computer having a client application resident thereon or a host computer having a server application resident thereon or other apparatus configured to execute program code embodied within computer usable media, may operate as means for performing the various functions and carries out the methods of the various operations of the present invention.

The illustrated system of FIG. 1 may be utilized to determine the legal requirements of one or more legal jurisdictions, in accordance with aspects of the present invention. In addition, the system of FIG. 1 may be part of a telemedicine system wherein a health provider located at computer 10 is in communication with a health provider located at computer 20.

Using the present invention, a referring health care provider may build a dermatological consult record and transmit that record to a consulting provider where the consulting provider may provide a diagnosis and recommended treatment for the patient and transmit same back to the referring provider and/or to a central treatment repository. For example, a health care provider in North Carolina may examine a patient and require the assistance of a specialist who is resident in Vermont. The present invention allows the North Carolina provider to prepare a consult record with the information necessary for the specialist to make a diagnosis and render a recommendation. The consult record may be transmitted over a computer network so the specialist has almost instant access to the consult record. The specialist in Vermont can make his diagnosis and recommendations for treatment and transmit them back to the North Carolina provider. All of this may be done while the patient is still in the North Carolina provider's office within a matter of moments. The patient may then be treated and dismissed. In addition, the consult records may be stored in a central repository for later review.

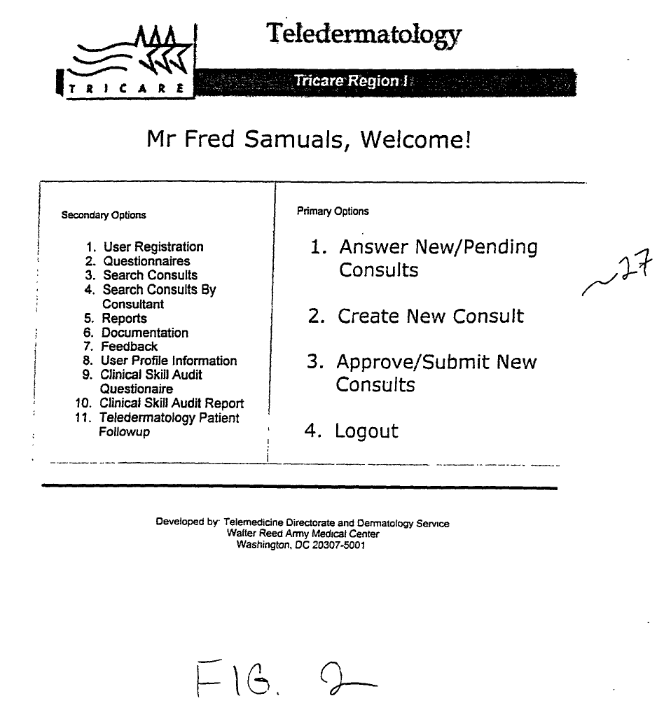

Referring now to FIGS. 2-?, exemplary user interfaces that assist the user in creating the dermatological consult record, according to one embodiment of the present invention, are illustrated. Upon logging on to the system, the user is initially presented with a user interface 27 displaying a number of user options each in the form of links. The user options are separated into primary options and secondary options.

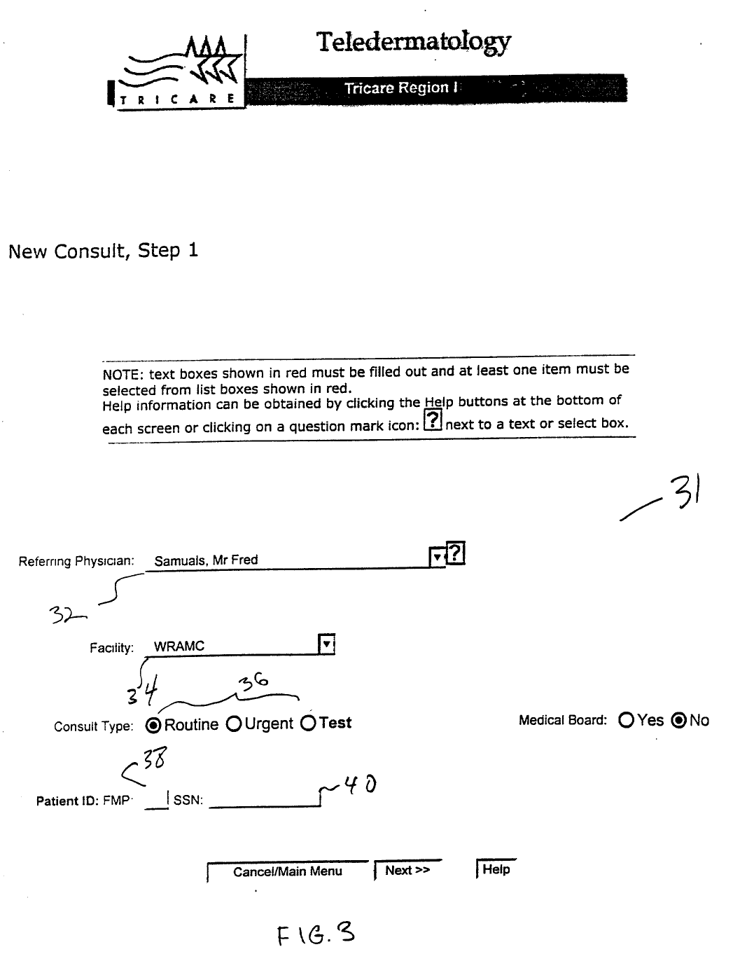

The user is presented with the user interface 31 depicted in FIG. 3. upon selection of the “Create New Consult” option. Typically a user who selects this option is a referring provider. User interface 31 includes a plurality of prompts for entry of data. As used herein, the term prompt refers to any user interface element that allows input or selection of data. Exemplary prompts include dialog boxes, radio buttons, pull down menus, links, interactive graphical representations, etc. A dialog box 32 is provided for user entry of the referring physician. Dialog box 32 includes a drop down menu so that the user is presented with a list of registered referring physicians. Accordingly, the user can select the name of the appropriate referring physician. Alternatively, the user could type in the referring physicians name. When the client recognizes the physcians name, the name is automatically selected from the list without further text input from the user. Another dialog box 34 is provided for with a pull down menu including a list of treating facilities. Like dialog box 32, the user may select the appropriate treating facility from the pull down menu. User interface 31 further includes a plurality of radio buttons 36 for classifying the type of consult being created. In the illustrated embodiment there are three choices, one for a routine consult, one for an urgent consult and one for a test consult. Routine consult requests receive a response within 72 hours. Urgent consult requests are preferably scheduled to receive a response as soon as possible, typically within the same day. Test consults are used for training purposes and have no priority for response. Dialog boxes 38 and 40 are provided for patient identification information. More particularly, dialog box 38 is provided for user entry of a patient code. In the illustrated embodiment, dialog box 38 is provided for entry of a two digit military code. However, the user interface may be modified to accept any administrative code that facilitates identification of the patient. Box 40 is provided for entry of the patient's social security number.

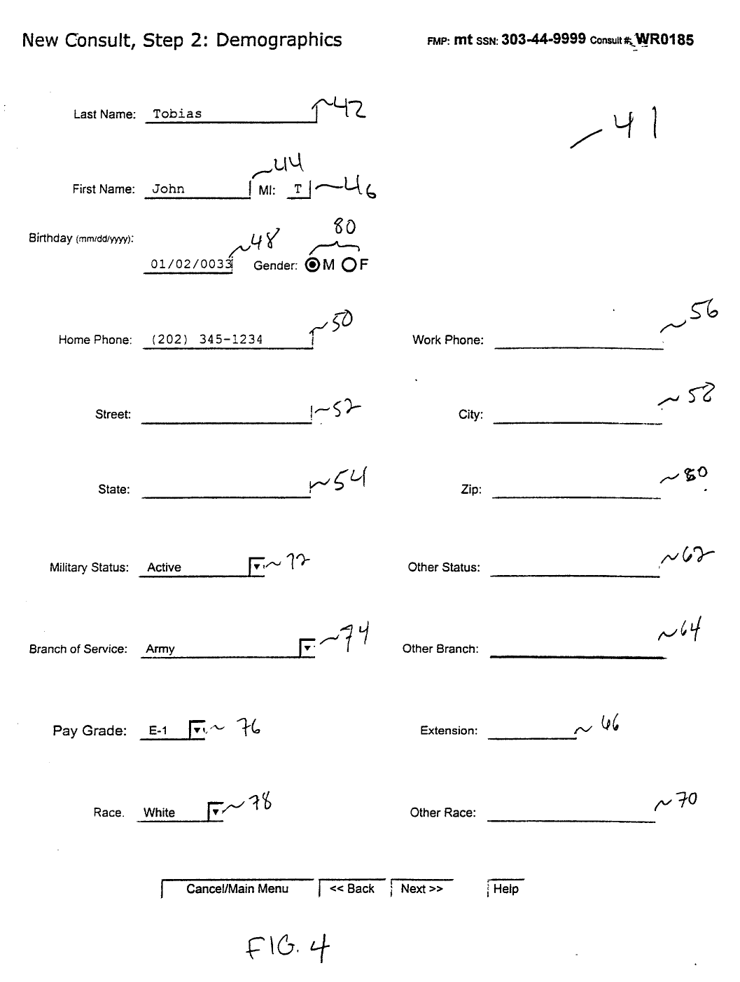

When the user has entered sufficient data into the user interface 31, the user selects the “next” prompt and is presented with user interface 41 depicted in FIG. 4 and all data entered and selected in connection with the user interface 31 is stored in an appropriate database. User interface 41 includes a plurality of prompts for patient demographic data. More particularly, dialog boxes 42-70, drop down menus 72-78 and radio buttons 80 are provided for last name, first name, birthday, home phone, street address, state, work phone, city, zip code, military status, other status, identification of service branch, other branch, pay grade, extension, race, and other race. Some of the prompts contained in user interface 41 may be eliminated in accordance with the desired use of the system. That is, user interface 41 is designed for use in a military institution. However, the program may be used in connection with other institutions. Accordingly, dialog boxes 62-66 and drop down menus 72-76 may be eliminated.

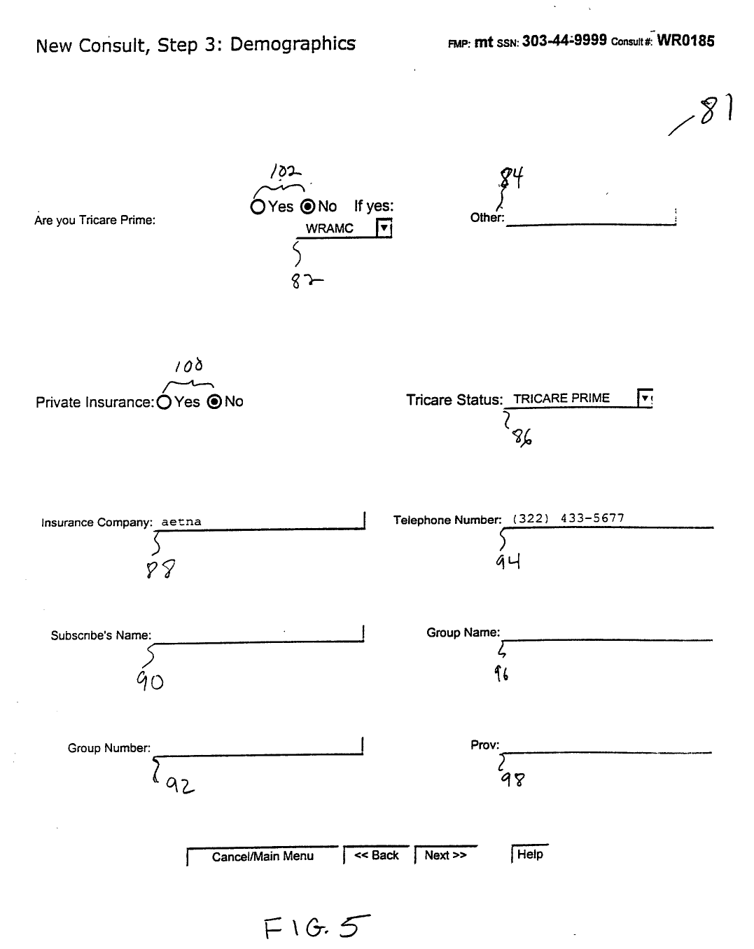

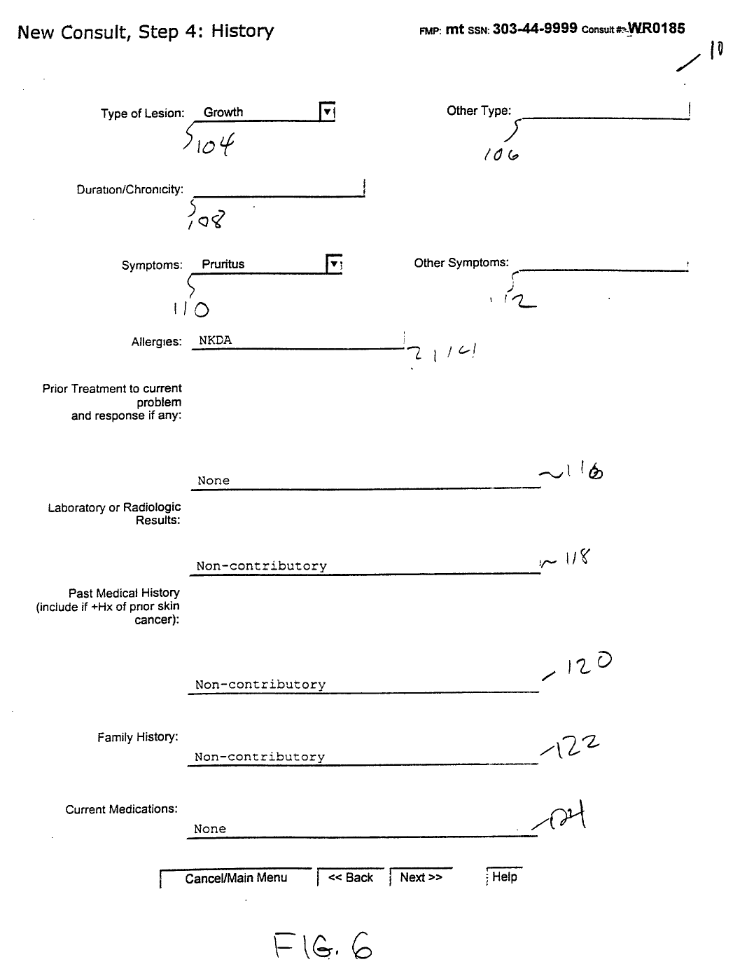

Next, the user is provided with user interface 81 shown in FIG. 5. User interface 81 includes a plurality of prompts for referring provider demographic data. More particularly, dialog boxes 84 and 88-98, drop down menus 82 and 86, and radio buttons 100 and 102 are provided for indication of insurance affiliation. Accordingly, interface 81 facilitates communication with insurance company databases.

In accordance with the invention, upon entry of the patient and provider demographic information described above, user interface 103 is provided for collection of data related to the patient's dermatological history. The provider may gather this data from examination of the patient. Certain data may also be uploaded from a medical record database. Drop down menu 104 is provided for entry of a type of lesion appearing on the patient's skin. The term “lesion” is used herein in its commonly known medical sense to mean an abnormal change in structure of an organ due to injury or disease. Lesions may be comprised of multiple sub-lesions described in more detail below. Specifically, drop down menu 104 includes a list including the following types of lesions: a) Growth, b) pigmented lesions and c) rash. As used herein in connection with drop down menu 104, “growth” refers to a single or few discrete sub-lesions including papules, nodules, mass and plaque. Exemplary growths include warts, bug bites, pyogenic granuloma, actinic keratosis, and basal cell carcinoma. Further, as used herein, “pigmented lesions” refers a single or a few lesions that have a dark color (blue, black, brown) and that may or may not be raised and palpable. Examples of pigmented lesions include seborrheic keratosis, nevi, caf6 au lait, spots and melanoma. Still further, as used herein, “rash” refers to multiple generalized sub-lesions or confluent eruptions covering a large surface area. Examples of rashes include drug eruptions, viral exanthem, and contact dermatitis. Dialog box 106 is provided for entry of a type of lesion that does not fit into any of the growth, pigmented granuloma or rash categories.

User interface 103 also includes dialog box 108 for entry of the duration or chronicity of the lesion. That is, the referring provider may enter how long the lesion has been present and the frequency of its occurrence.

Drop down menu 110 is provided for entry of the patient's symptoms. Drop down menu 110 includes a list of the following symptoms: 1) pruritus (the lesion itches), 2) pain, 3) burning, 4) tenderness, and 5) none (the lesion is asymptomatic). Dialog box 112 is provided for entry of symptoms that do not appear in drop down menu 110. A particularly important item of patient history is the patient's allergy history. Accordingly, dialog box 114 is provided for entry of any known allergies from which the patient suffers.

It is important for the consulting provider be aware of the information input to dialog boxes 106, 108, 112 and 114 and selected from drop down menus 104 and 110 in order to provide a reliable diagnosis and treatment recommendation. However, other patient history information is also useful to the consulting provider. To that end, user interface 103 is also provided with dialog boxes 116, 118, 120, 122 and 124 for entry of further patient history information. Dialog box 116 prompts the user for any prior treatment that the patient may have undergone for the patient's current problem. The user should also include the patient's response to the treatment, if any. An exemplary entry to dialog box 116 may read, “topical steroids×2 weeks—no improvement. Dialog box 118 prompts the user any test results including laboratory tests, or radiological tests (CAT scans, MRI's etc.). Dialog box 120 prompts the user for entry of any appropriate prior medical events for the patient as they relate to the current condition. An exemplary entry for dialog box 120 may read “Hx of melanoma or basal cell carcinoma”. Dialog box 122 prompts the user for entry of the patient's family history and dialog box 124 prompts the user for entry of the patient's current medications.

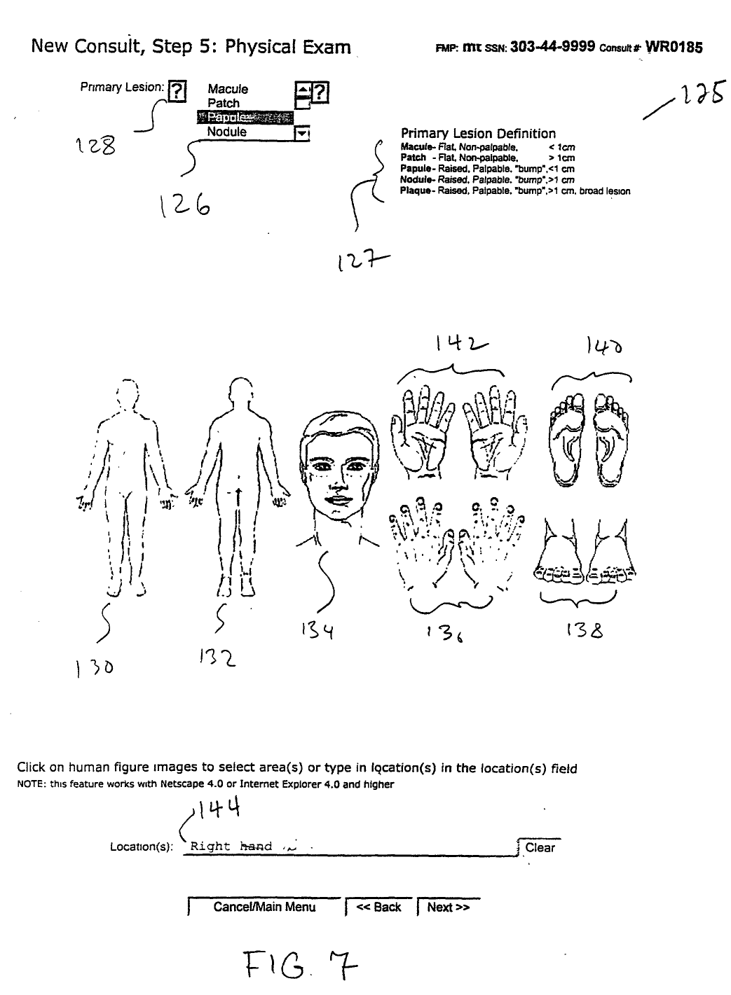

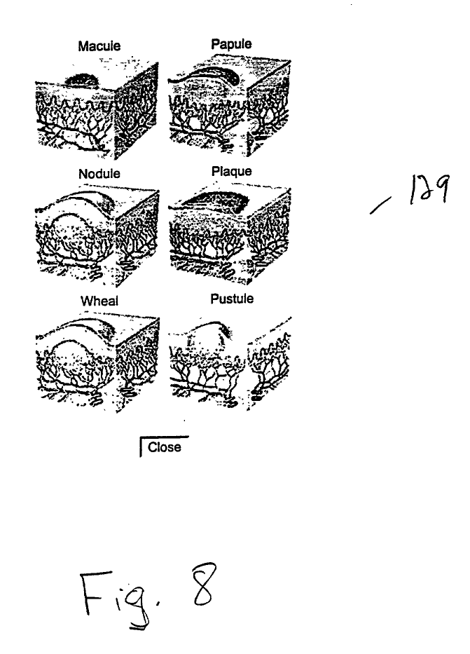

Referring now to FIG. 7, the user is presented, via user interface 125, for classifying the patient's primary lesion, i.e., identifying the sub-lesions that comprise the lesion, and for identifying the area or areas on the body where the lesions are present. Drop down menu 126 includes a list of types sub-lesions including macules, patches, papules, nodules, and plaque. To assist the user in classifying the primary lesion, a text field 127 is provided that includes definitions of each type of sub lesion. To further assist the user, a help icon 128 is provided. When the user clicks on the help icon user interface 129 depicted in FIG. 8 is displayed. Interface 129 depicts a graphical representation of each sub-lesion which gives the user a visual point of reference to compare with the patient. Accordingly, interface 129 greatly increases the chances that the user will select the correct sub-lesion in drop down menu 126, especially if the user is unfamiliar with dermatology.

Dialog box 144 is provided for entry of the location or locations of the lesions on the patient's body. In accordance with a preferred aspect of the invention, user interface 125 is provided with a plurality of interactive graphical representations of human body parts 130, 132, 134, 136, 138, 140 and 142. Each interactive graphical representation is provided with functionality such that when the user selects an area of the body with pointing device 13, the textual description of that area automatically appears in dialog box 144. For example, in FIG. 8, the user has selected the right hand of element 142. Accordingly, the text “right palm” appears in dialog box 144.

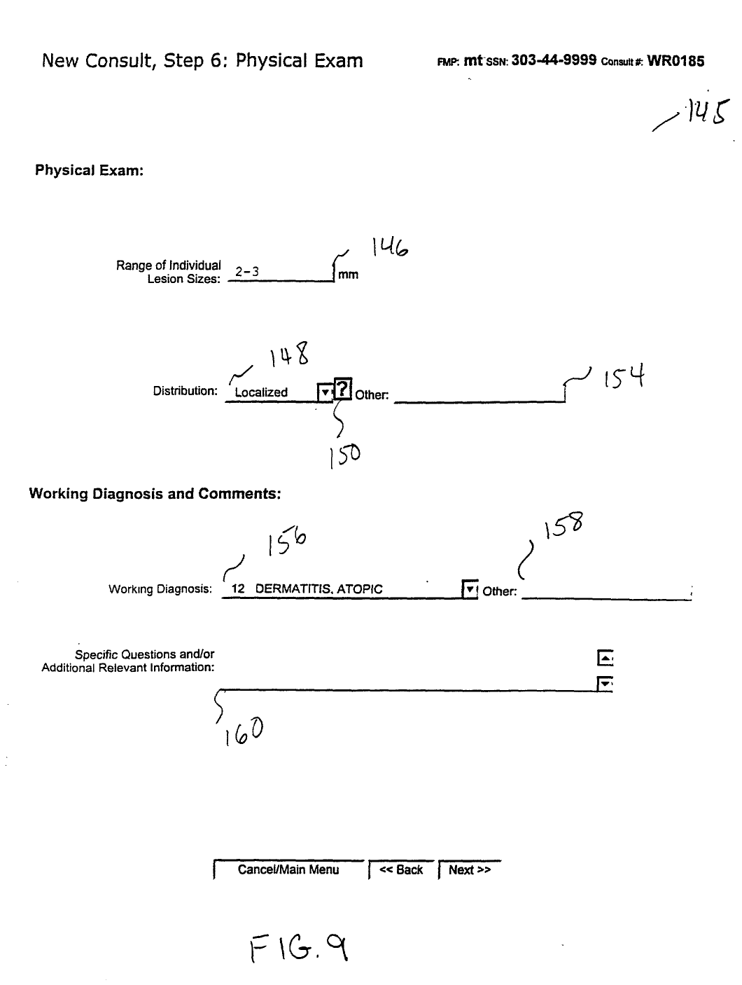

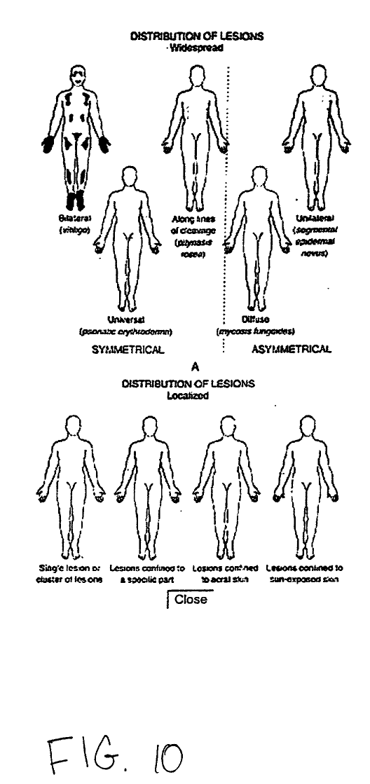

Referring now to FIG. 9, it depicts user interface 145. User interface 145 included dialog box 146 for entry of a range of individual lesion sizes. Preferably, the user enters the diameter or cross measurements (length×width) of the smallest and largest lesion or lists the size of each lesion if the patient has only a few lesions. User interface 145 further provides a drop down menu 148 for defining the distribution of lesions along the patient's body. Drop down menu 148 includes a list of distributions. The first distribution is “single” and it refers to one lesion. The next distribution is “localized” which refers to several lesions, but in one anatomic region, e.g., the arm or the groin. The next distribution is “widespread” which refers to generalized lesions or rash covering multiple anatomic regions. The next distribution is “acral”, i.e., only involving the hands and feet. The last distribution is “truncal”, i.e., only involving the trunk (chest, abdomen, back). The foregoing are by far the most common distributions. However, dialog box 154 is provided for entry of any distribution that does match those listed in drop down menu 148. To better assist the user in matching the lesion distribution present on the patient with the distributions listed in drop down menu 148, the user may select help icon 150 which opens a window, FIG. 10, showing a plurality of graphical representations of human figures having shaded areas corresponding to the distributions listed in drop down menu 148 and further classifying those distributions.

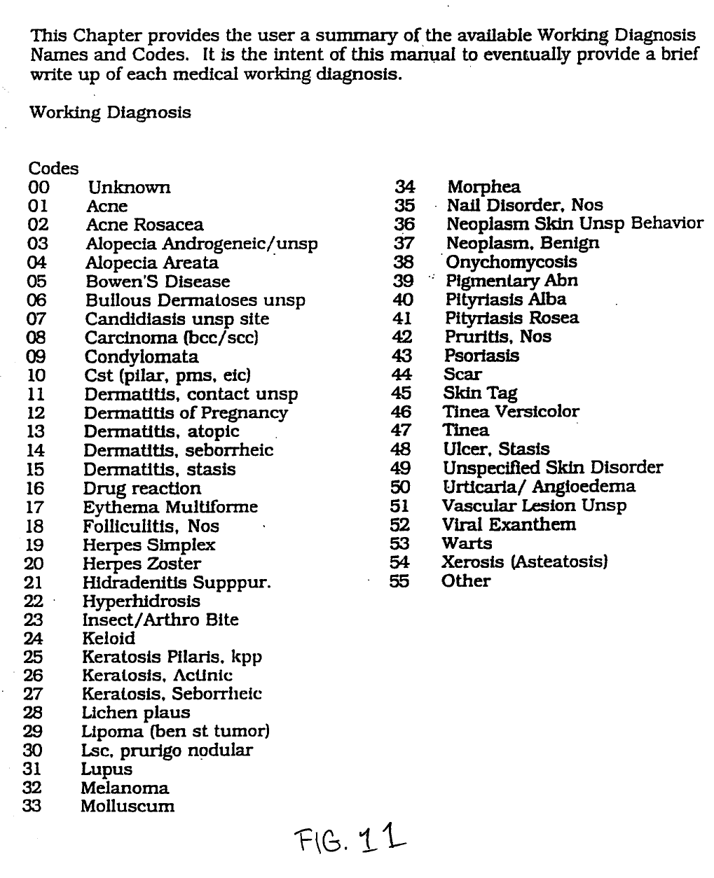

Based at least on the data entered into user interfaces103 and 125, the user may make a working diagnosis. In keeping with the invention, user interface 145 includes a drop down menu 156 for entry of a working diagnosis by the user. Drop down menu 156 may include an infinite number of working diagnosis. In a preferred embodiment, drop down menu 156 includes the working diagnosis set forth in FIG. 11. Interface 145 is further provided with dialog box 158 for entry of working diagnosis that does not appear in drop down menu 156.

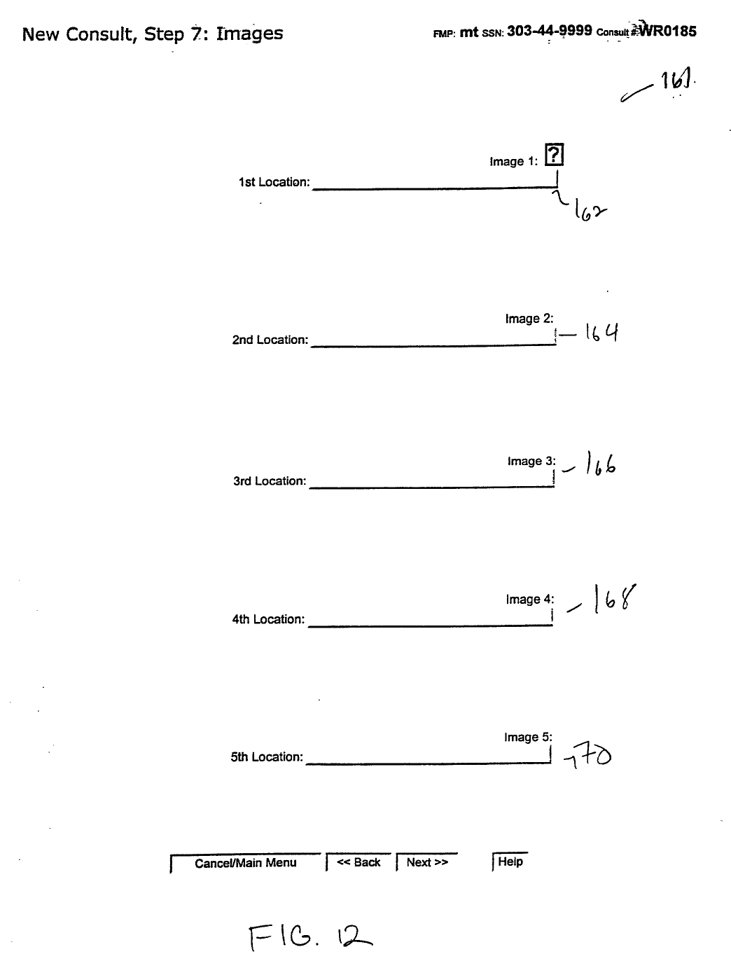

One of the tools that is most useful to the consulting provider in making a diagnosis and recommendation is to actually view the lesions. Hence, the invention provides a user interface 161 for uploading images of the patient's lesions. As illustrated in FIG. 12, five dialog boxes, 162, 164, 166, 168 and 170 are provided for uploading images to user interface 161. However, in accordance with the invention, either greater or fewer images may be uploaded depending on the system designers preference. Once the images are uploaded, the user has entered all data needed to create the dermatological consult record. However, before the dermatological consult record is actually created, the consult must be approved. Typically, approval must be made by the referring provider.

All data entered into each of the above referenced user interfaces is stored for future access as the user successively scrolls through the interfaces. In addition, in accordance with an aspect of the invention, a designated consulting provider may be notified immediately upon approval of a dermatological consult record, preferably via email.

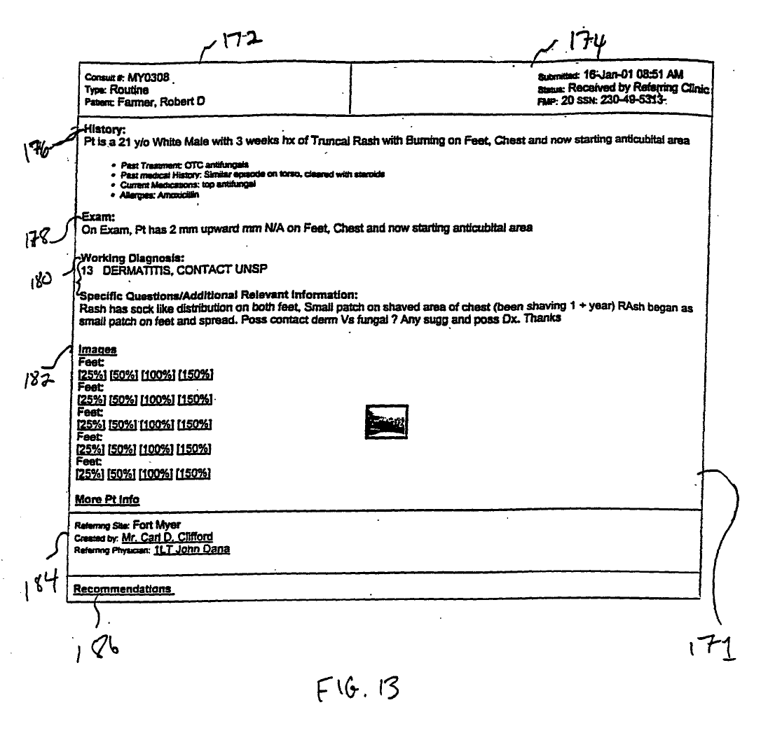

To facilitate a consultation, the consulting provider logs into a user computer 10 and is presented with user interface 27. The consulting provider selects the “Answer New/Pending Consult” and is provided with a dermatological consult record in the form of user interface 171. FIG. 13 illustrates user interface 171 which includes a first data field displaying the consult number, the type of consult and the patient's name. A second data field 174 is provided displaying the date and time of consult submission, the status of the consult and the patient's code and social security number. History data field is provided that displays the patient history data input to user interface 103. An examination data field 178 is provided that displays data relating to the patient's physical exam results input to user interfaces 125 and 145. A diagnosis data field 180 is provided that displays data the referring provider's working diagnosis and any additional comments of the referring provider relating to the patient's condition. The data in the diagnosis data field is data that was input to user interface 145. User interface 171 is further provided with an image data field 182 displaying images uploaded to user interface 161. The image data field preferably includes links for enlarging and shrinking the images. A third miscellaneous data field is provided showing the referring site, the dermatological consult record creator and the referring provider.

In accordance with a preferred aspect of the invention, user interface 171 further includes a link to a prompt for the consulting provider that allows the consulting provider to input his diagnosis and recommended treatment for the patient. This information is appended to the dermatological consult record and the record is preferably stored in host computer 20 for retrieval by the referring provider.

What is claimed is:

2. A method in a computer system for displaying a patient's dermatological consult record comprising:
displaying one or more prompts for entry of data relating to the patient's dermatological history;
displaying one or more prompts for entry of data relating to physical examination of the patient;
displaying one or more prompts for selection of images of body parts of the patient populated with dermatological abnormalities; and
in response to entry of the patient's dermatological history data, the patient's examination results and the selection of images, displaying a dermatological consult record including a patient history data field, a physical examination data field and an image data field.

3. The method according to claim 1 wherein displaying one or more prompts for entry of data relating to the patient's dermatological history includes displaying a dialog box for entry of a type of lesion.

4. The method according to claim 1 wherein displaying one or more prompts for entry of data relating to the patient's dermatological history includes displaying a dialog box for entry of the duration or chronicity of the lesion.

5. The method according to claim 1 wherein displaying one or more prompts for entry of data relating to the patient's dermatological history includes displaying a dialog box for entry of the patient's symptoms.

6. The method according to claim 1 wherein displaying one or more prompts for entry of data relating to the patient's dermatological history includes displaying a dialog box for entry of the patient's allergies.

7. The method according to claim 1 wherein displaying one or more prompts for entry of data relating to the patient's dermatological history includes displaying a dialog box for entry of prior treatment of lesions received by the patient.

8. The method according to claim 1 wherein displaying one or more prompts for entry of data relating to the patient's dermatological history includes displaying a dialog box for entry of test results.

9. The method according to claim 1 wherein displaying one or more prompts for entry of data relating to the patient's dermatological history includes displaying a dialog box for entry of the patient's current medications.

10. The method according to claim 1 wherein displaying one or more prompts for entry of data relating to the patient's dermatological history includes displaying a dialog box for entry the patient's family's dermatological history.

11. The method according to claim 1 wherein displaying one or more prompts for entry of data relating to the patient's dermatological history includes displaying a dialog box for entry of the patient's past medical history.

12. The method according to claim 1 wherein displaying one or more prompts for entry of data relating to physical examination of the patient includes displaying a dialog box for entry of a type of a sub-lesion, wherein a lesion comprises one or more sub-lesions.

13. The method according to claim 11 further comprising displaying a graphical representation of a plurality of types of lesions in response to selection of an icon.

14. The method according to claim 1 wherein displaying one or more prompts for entry of data relating to physical examination of the patient includes displaying a dialog box for entry of a location on a patient's body at which the lesion appears.

15. The method according to claim 1 wherein displaying one or more prompts for entry of data relating to physical examination of the patient includes displaying an interactive graphical representation of one or more body parts, at least a portion of the interactive graphical representation displaying a visual indicator responsive to selection of the portion of the interactive graphical representation.

16. The method according to claim 1 wherein displaying one or more prompts for entry of data relating to physical examination results of the patient includes displaying a dialog box for entry of a range of lesion sizes.

17. The method according to claim 1 wherein displaying one or more prompts for entry of data relating to physical examination results of the patient includes displaying a dialog box for entry of a distribution of lesions.

18. The method according to claim 1 further comprising, responsive to selection of an icon, displaying a plurality of graphical representations of a body, each graphical representation exhibiting a different distribution of lesions.

19. The method according to claim 1 wherein displaying one or more prompts for entry of data relating to physical examination results of the patient includes displaying a dialog box for entry of a working diagnosis for a patients dermatological condition.

20. The method of claim 1 wherein displaying one or more prompts for selection of images of the patient's body parts populated with dermatological abnormalities includes displaying one or more menus for selection the images of the patient's body parts populated with lesions.

21. A computer program product for generating a patient's dermatological consult record, the computer program product comprising a computer readable storage medium having computer readable program code embodied in the medium, the computer readable program code comprising:
program code means for causing a computer to display one or more prompts for entry of data relating to the patient's dermatological history;
program code means for causing a computer to display one or more prompts for entry of data relating to physical examination of the patient;
program code means for causing a computer to display one or more prompts for selection of images of body parts of the patient populated with dermatological abnormalities; and
program code means for, in response to entry of the patient's dermatological history data, the patient's examination results and the selection of images, generating a dermatological consult record including a patient history data field, a physical examination data field and an image data field.
